(19) United States
(12) Patent Application Publication
(10) Pub. No.: US 2002/0037952 A1
(43) Pub. Date: Mar. 28, 2002

(54) Coating material for making high temperature resistant sealing elements

(76) Inventor: Hans-Rainer Zerfass, Taunusstein (DE)

Correspondence Address: Edward J. Timmer, Walnut Woods Center, 5955 W. Main Street, Kalamazoo, MI, 49009, US

(21) Appl. No.: 09/888,739

(22) Filed: Jun. 25, 2001

(30) Foreign Application Priority Data
Aug. 4, 2000 (DE) 100 37 965.6

(51) Int. Cl. C08K 3/38

(52) U.S. Cl. 524/404; 524/496; 428/457; 428/462

(57) ABSTRACT

To obtain a coating material with which high temperature resistant sealing elements can be made, particularly in the form of coatings on metal surfaces, it is proposed that the coating material should comprise a film-forming binding agent, a solvent for it and a high temperature resistant solid lubricant.

The invention relates to a coating material for making high temperature resistant sealing elements, particularly on metallic surfaces.

In modern internal combustion engines high demands are made of the gas tightness of the exhaust system, particularly if combustion is controlled by so-called lambda probes. High temperature resistant seals are required owing to the temperatures which occur, in the 700-900° C. range.

Impermeability is naturally affected both by the roughness of the surfaces of the components and by the flexibility of those of the sealing materials. In the exhaust region metal seals with impressed beading may inter alia be used for sealing.

It is found in practice though that the desired low leakage rates cannot be obtained with such seals. In order to make flat metallic seals more impermeable they are usually provided with elastomeric coatings. Elastomeric coatings are not however resistant enough for this high temperature application.

The object of the present invention is to propose a coating material with which high temperature resistant sealing elements can be made, particularly in the form of coatings for metal surfaces.

In the coating material described above the problem is solved, according to the invention, in that the material comprises a film-forming binding agent, a solvent therefor and a solid lubricant which is resistant to high temperatures.

High temperature resistant, solid lubricants have indeed been used in the past in connection with coating compositions, particularly for metal layer seals (see e.g. DE 198 33 063 A1). However coatings of that type which seal in the long run are always used in a mixture of solid lubricants and binding agents. The silicon-containing binding agents which are preferably used have the drawback of forming silicon dioxide at operating temperatures of 700° C. and above, and this substance impairs the flexibility of the coating composition produced by the soft solid lubricant.

In contrast with this the binding agent used in the present case is only employed as a transporting medium, to keep the solid lubricants in position until the seal has been fitted in its place of use. The binding agent itself need not have any particular temperature resistance; on the contrary it is preferably selected so that it is thermally decomposed when used at temperatures of 700° C. and over and thus only leaves behind the solid lubricants. The solvents for the binding agent have already been removed by drying when the coating material is dried on the metal surface.

Some examples of suitable solid lubricants are graphite, boron nitride or mixtures of these materials.

The solid lubricant will preferably be in particle form, particularly in granular or lamellar form, and the solid lubricant particles will preferably have a mean size of 0.5 to 15 μm.

The coating materials according to the invention preferably contain binding agents in a proportion of 50% by weight or less in view of their mere carrier function.

The mass ratio of the solid lubricant content to the binding agent content is preferably within the 1:1 to 3:1 range.

The binding agent is preferably selected to include a lacquer which forms an elastic film during the drying of the coating material.

The solvent content of the coating materials according to the invention is preferably 30% by weight or more. The solvent is an important constituent of the coating material according to the invention (in contrast with DE 198 33 063 which works without solvent) and chiefly enables the coating material to be applied as thinly as possible to the metal surfaces to be coated. Thus the coating material according to the invention is suitable not only for coating certain regions but also for coating the entire area of the metal layers of a seal.

Preferred coating materials additionally have a content of elastomer, whereby the mechanical insensitivity of the coating is ensured until the sealing layers are installed in the envisaged place of use.

The elastomer content of the coating material is preferably 5 to 15% by weight relative to the total contents of binding agent and solid lubricant.

According to the invention the coating materials described above for making sealing elements are used on surfaces of metal sheets, particularly in the form of very thin coatings.

The invention further concerns the use of the coating materials for making sealing elements on metal sheets, wherein the metal sheets can subsequently be spot welded to make the sealing elements.

The coating with the coating material surprisingly does not interfere with spot welding, and consequently further members of the seals can be spot welded whether or not a coating of the material according to the invention is present.

The invention further relates to use of the coating material according to the invention for making sealing elements, with the binding agent being thermally decomposed at a later stage. The coating surprisingly does not lose its sealing action even through the burning out or thermal decomposition of the binding agent.

The invention also concerns single or multi-layer metal layer seals with one or more sealing elements which are produced on one of the surfaces of one of the metal layers, from one of the previously described coating materials. Such metal layer seals have very low leakage rates even if used at high temperatures, even when a binding agent is used and the operation is carried out within a temperature range where the binding agent is thermally decomposed and in the end only the heat-resistant solid lubricants are left on the metal surface.

In the coating material according to the invention soft solid lubricants are preferably used; examples of these have already been given in the form of graphite and boron nitride. They are particularly appropriate for filling out and reducing the roughness of the metal surface.

As the binding agent has substantially no effect on impermeability and can be thermally decomposed and thus removed from the coating, it can be chosen so that the coating material can be processed as well as possible in the production of the seals.

A multiplicity of lacquers forming elastic films are suitable for use as binding agents. Thermal decomposition of the binding agents normally takes place during the first operating hours of the seal fitted in the exhaust system.

These and other advantages of the invention will be further explained below with reference to examples.

### EXAMPLES

Three different examples of formulations are given in the following table, the figures for the content of the various constituents of the coating materials being parts by weight in each case. The solvent content of the formulation is given as a percentage by weight relative to the total formulation.

Suitable solvents may be esters such as n-butyl acetate, 2-methoxy-1-methylethyl acetate or ketones such as methylethyl ketone, or mixtures of these solvents.

In the solid lubricants used in the examples the particle sizes are within the 1-5 μm range in the case of boron nitride and within the 3-8 μm range in the case of graphite.

| | Formulation 1 | Formulation 2 | Formulation 3 |
|---|---|---|---|
| Raw material | Parts by mass | Parts by mass | Parts by mass |
| Epoxy resin | 1.62 | 0.90 | — |
| Phenolic resin | 1.08 | 0.45 | — |
| PU resin | — | — | 1.00 |
| NBR rubber | — | 0.45 | — |
| Graphite | 2.70 | 1.80 | 2.00 |
| Boron nitride | 1.35 | 0.90 | 1.00 |
| Solvent | 8.26 | 5.50 | 6.00 |
| Ratio lubricant: | 1.5:1 | 1.5:1 | 3:1 |
| binding agent | | | |
| Solvent content | 55 | 55 | 40 |
| % by weight | | | |

Coating materials were made from the formulations given in the table for Examples 1 to 3, and applied with a coat thickness of 20 μm to a metal surface with a surface roughness RZ of approximately 25 μm.

The subsequent tests where the leakage rates were determined were carried out at a pressure of 0.3 bar above atmospheric.

When non-coated metal sheets were used a leakage rate of 300 μl/min was obtained after the test run in the exhaust system at temperatures of approx. 950° C. (duration 100 h).

When the coating material according to the invention was employed, at a coating thickness of 20 μm, a leakage rate of 18 μl/min was obtained after the test run, which was carried out under the same conditions as for the non-coated surface; a leakage rate of 10 μl/min was obtained before the test run.

It will be seen from these figures that thermal decomposition of the binding agent content of the coating composition according to the invention has little effect on the leakage rate, and that leakage rates far below the otherwise normal levels are achieved, particularly in continuous operation.

1. A coating material for making high temperature resistant sealing elements, particularly on metallic surfaces, characterised in that the coating material comprises a film-forming binding agent, a solvent for it and a high temperature resistant solid lubricant.

2. A coating material according to claim 1, characterised in that the solid lubricant is chosen from graphite, boron nitride or mixtures of these materials.

3. A coating material according to claim 1 or 2, characterised in that the solid lubricant is in particle form, particularly being granular or lamellar, and the solid lubricant particles have a mean particle size of 0.5 to 15 μm.

4. A coating material according to any of claims 1 to 3, characterised in that the binding agent is present in the coating material in a content of 50% or less by weight of the solids content.

5. A coating material according to claim 4, characterised in that the mass ratio of the solid lubricant and binding agent contents is within the 1:1 to 3:1 range.

6. A coating material according to any of claims 1 to 5, characterised in that the binding agent can be thermally decomposed above 700° C.

7. A coating material according to any of claims 1 to 6, characterised in that the binding agent includes a lacquer which forms an elastic film during the drying of the coating material.

8. A coating material according to any of claims 1 to 7, characterised in that the solvent content of the coating material is 30% or more by weight.

9. A coating material according to any of claims 1 to 8, characterised in that the coating material contains a proportion of an elastomer.

10. A coating material according to claim 9, characterised in that the elastomer content of the coating material is 5 to 15% by weight relative to the total contents of binding agent and solid lubricant.

11. Use of a coating material according to any of claims 1 to 10 for making sealing elements on surfaces of metal sheets.

12. The use according to claim 11, characterised in that the metal sheets are subsequently spot welded to make the sealing elements.

13. The use according to claim 11 or 12, characterised in that the binding agent is thermally decomposed.

14. A single or multi-layer metal layer seal with one or more sealing elements, which are made on one of the surfaces of one of the metal layers, from a coating material according to any of claims 1 to 10.

15. A metal layer seal according to claim 14, characterised in that the binding agent is thermally decomposed.
